(19) United States
(12) Patent Application Publication
(10) Pub. No.: US 2017/0253134 A1
(43) Pub. Date: Sep. 7, 2017

(54) System and Method for Charging an Electrical Energy Store of a Vehicle

(71) Applicant: Bayerische Motoren Werke Aktiengesellschaft, Muenchen (DE)

(72) Inventors: Jens Berger, Muenchen (DE); Thorsten Kuenzig, Muenchen (DE); Nicolai Kraemer, Muenchen (DE)

(21) Appl. No.: 15/598,700

(22) Filed: May 18, 2017

Related U.S. Application Data
(63) Continuation of application No. PCT/EP2015/076781, filed on Nov. 17, 2015.

(30) Foreign Application Priority Data
Nov. 19, 2014 (DE) 10 2014 223 585.5

(51) Int. Cl. B60L 11/18; B60L 3/04; H02J 7/00; B60L 3/00

(52) U.S. Cl. CPC B60L 11/1812; B60L 11/185; B60L 3/0092; B60L 3/04; B60L 11/1818; H02J 7/0045; H02J 7/0026; B60L 2210/30

(57) ABSTRACT

A system for charging an electrical energy store of a vehicle includes a vehicle and a charging apparatus coupled to a power supply system. The vehicle comprises a plug with a first group of first contacts and a second group of second contacts, wherein, in order to form a first current path, the first contacts of the first group are coupled to the electrical energy store of the vehicle by a first voltage converter which is controllable by a first charge control unit. Moreover, in order to form a second current path, the second contacts of the second group is coupled to the electrical energy store of the vehicle by a first switching device, wherein the switching states of said first switching device are controllable by the first charge control unit.

### CROSS REFERENCE TO RELATED APPLICATIONS

This application is a continuation of PCT International Application No. PCT/EP2015/076781, filed Nov. 17, 2015, which claims priority under 35 U.S.C. §119 from German Patent Application No. 10 2014 223 585.5, filed Nov. 19, 2014, the entire disclosures of which are herein expressly incorporated by reference.

### BACKGROUND AND SUMMARY OF THE INVENTION

The invention relates to a system and to a method for charging an electrical energy store of a vehicle. The invention further relates to a vehicle and also to a charging apparatus for charging the electrical energy store of the vehicle.

Electrically operated vehicles, such as, for example, battery-operated vehicles (BEV) or plug-in hybrid electric vehicles (PHEV) which have an internal combustion engine and an electric drive, comprise an electrical energy store which can be charged by means of a charging apparatus which is connected to the power supply system. The electrical energy store can be charged in different charging modes depending on the design of the charging apparatus and/or of the vehicle. For example, slow charging from domestic Schuko power sockets can be performed. Another charging mode is single- to three-phase charging. Furthermore, charging with a specific charging plug system and also charging with control can be performed. The different charging modes are specified in IEC 61851-1.

The so-called “Combined AC/DC Charging System” (CCS) is a charging plug system for electric vehicles in accordance with IEC 62196 and supports both charging with alternating current (AC charging) and charging with direct current (DC charging). The CCS substantially comprises a vehicle-side plug (vehicle inlet), the so-called inlet, and the two couplings of the charging apparatus for AC and DC charging (vehicle connector). Owing to the universal plug system, only one charging interface is required on the vehicle side in order to cover the different charging options, such as AC or DC charging. Communication between the electric vehicle and the charging apparatus is made possible and the charging process of the electrical energy store of the vehicle is controlled in a targeted manner by means of two signal contacts, that is to say contacts for transmitting control and communication data (the pilot contact CP (Control Pilot) and proximity switch PP (Proximity Pilot, Plug Present)). On account of the dimensions of DC contacts being larger than those of the contacts for AC charging, currents of up to 200 A are possible in the case of DC charging. Rapid charging, for example charging on-the-go, can be realized in this case.

Although the CCS provides a large degree of flexibility in respect of the supported charging modes, a further improvement in charging of the electrical energy store of an electrically operated vehicle is desired. The object of the present invention is therefore to specify a system for charging an electrical energy store and also a method for charging an electrical energy store, which system and method are functionally and/or structurally improved. A further object is to specify a charging apparatus of corresponding design and also a vehicle.

A system for charging an electrical energy store of a vehicle is proposed for achieving the object. Said system comprises a vehicle and a charging apparatus which is coupled to a power supply system. The vehicle comprises a plug (so-called vehicle inlet) with a first group of first contacts and a second group of second contacts, wherein, in order to form a first current path, the first contacts of the first group are coupled to the electrical energy store of the vehicle by means of a first voltage converter which can be controlled by a first charge control unit, and wherein, in order to form a second current path, the second contacts of the second group is coupled to the electrical energy store of the vehicle by means of a first switching device, it being possible for the switching states of said first switching device to be controlled by the first charge control unit.

The charging apparatus comprises a first coupling (so-called vehicle connector) with a third number of third contacts, which first coupling can be connected to the first group of first contacts of the plug by means of the first current path in order to charge the electrical energy store of the vehicle using alternating current, and which first coupling is coupled to the power supply system by means of a second switching device, it being possible for the switching states of said second switching device to be controlled by a second charge control unit. The charging apparatus further comprises a second coupling (vehicle connector) with a fourth number of fourth contacts, which second coupling can be connected to the second group of second contacts of the plug by means of the second current path in order to charge the electrical energy store of the vehicle using direct current, and which second coupling is coupled to the power supply system by means of a second voltage converter which can be controlled by the second charge control unit.

In the system, the first and the second coupling of the charging apparatus are in the form of a common coupling (that is to say the first and the second coupling are combined in a common coupling housing), so that, when the common coupling is connected to the plug, the first contacts of the plug are electrically conductively connected to one another to the third contacts of the first coupling, and the second contacts of the plug are electrically conductively connected to one another to the fourth contacts of the second coupling. The first and the second charge control unit are designed to drive the first and the second voltage converter and the first and the second switching device such that current flow is made possible across the first and the second current drive simultaneously in order to charge the electrical energy store.

The proposed system for charging an electrical energy store of a vehicle allows parallel operation of AC charging and DC charging to be supported. This allows more efficient utilization of the charging interface and the subsystems which are incorporated in the vehicle. A higher charging power can be achieved by combining the two types of charging, AC charging (alternating current charging) and DC charging (direct current charging). Shorter charging times for charging the electrical energy store of the vehicle can be achieved owing to the higher charging power. Furthermore, the infrastructure-side charging apparatus is used more efficiently on account of the shorter charging times which are now possible. In comparison to a conventional charging system, this allows a vehicle to be charged more rapidly or allows a larger number of vehicles to be charged over the same time period.

The first charge control unit can be designed to switch off the first switching device and/or to switch off the first voltage converter when a fault occurs.

As an alternative or in addition, the second charge control unit can be designed to switch off the second switching device and/or to switch off the second voltage converter when a fault occurs.

Owing to these two design variants, it is possible to ensure that currents cannot flow in an undesirable manner between the charging apparatus and the vehicle when a fault occurs.

According to a further refinement, the first voltage converter can be designed in such a way that current flow in the direction of the charging apparatus is not possible across the first current path. As an alternative or in addition, the second voltage converter can be designed in such a way that current flow in the direction of the charging apparatus is not possible across the second current path.

The first and the second voltage converter can suppress undesired current flow in the direction of the charging apparatus by corresponding design for example. Similarly, explicit protective elements, such as, for example, controlled switches, diodes, etc., can be provided in order to suppress current flow from the vehicle side or the electrical energy store side in the direction of the charging apparatus.

According to a further refinement, it can also be provided that the first switching device comprises a protective arrangement which suppresses current flow in the direction of the charging apparatus. As an alternative or in addition, the second switching device can also comprise a protective arrangement which suppresses current flow in the direction of the charging apparatus. The protective arrangement can be realized, for example, by correspondingly designed diode elements or switching elements.

According to a further expedient refinement, the first charge control unit and the second charge control unit are designed to exchange messages by means of a communication path in order to simultaneously drive the first and the second voltage converter and also the first and the second switching device, wherein the communication path runs across selected contacts of the first group of first contacts and selected third contacts of the first coupling. The selected contacts, in particular two contacts, are not used for transmitting power. As an alternative, communication can also be provided by means of power-carrying contacts. The communication ensures that the first and the second charge control unit drive the first and the second voltage converter and also the first and the second switching device in synchronism. To this end, the first charge control unit can serve as a master and the second charge control unit can serve as a slave. Reversed logical splitting is also conceivable.

A vehicle according to the invention comprises an electrical energy store which can be charged by means of a charging apparatus. The vehicle comprises a plug (vehicle inlet) with a first group of first contacts and a second group of second contacts. In order to form a first current path, the first contacts of the first group are coupled to the electrical energy store of the vehicle by means of a first voltage converter which can be controlled by a charge control unit. In order to form a second current path, the second contacts of the second group are coupled to the electrical energy store of the vehicle by means of a first switching device, it being possible for the switching states of said first switching device to be controlled by the first charge control unit. The first charge control unit is designed to drive the first voltage converter and the first switching device such that current flow is made possible across the first and the second current path simultaneously in order to charge the electrical energy store when the first and the second contacts of the plug are electrically conductively connected to a coupling of the charging apparatus, which coupling corresponds to the plug and comprises third and fourth contact pins.

The vehicle has the same advantages as have been described above in conjunction with the system according to the invention for charging the electrical energy store of the vehicle.

In the vehicle according to the invention, the charge control unit can be designed to switch off the first switching device and/or to switch off the first voltage converter when a fault occurs. The first voltage converter can be designed in such a way that current flow in the direction of the charging apparatus is not possible or is suppressed across the first current path. The first switching device can comprise a protective arrangement which suppresses current flow in the direction of the charging apparatus.

The invention further proposes a charging apparatus for charging an electrical energy store of a vehicle which is designed as described above. The charging apparatus comprises a first coupling (vehicle connector) with a third number of third contacts, which first coupling can be connected to the first group of first contacts of the plug by means of the first current path in order to charge the electrical energy store of the vehicle using alternating current, and which first coupling is coupled to the power supply system by means of a second switching device, it being possible for the switching states of said second switching device to be controlled by a second charge control unit. The charging apparatus comprises a second coupling (vehicle connector) with a fourth number of fourth contacts, which second coupling can be connected to the second group of second contacts of the plug by the second current path in order to charge the electrical energy store of the vehicle using direct current, and which second coupling is coupled to the power supply system by means of a second voltage converter which can be controlled by the second charge control unit. The first and the second coupling of the charging apparatus are in the form of a common coupling (that is to say are combined in a common coupling housing), so that, when the common coupling is connected to the plug, the first contacts of the plug are electrically conductively connected to one another to the third contacts of the first coupling, and the second contacts of the plug are electrically conductively connected to one another to the fourth contacts of the second coupling. The second charge control unit is designed to drive the second voltage converter and the second switching device such that current flow is made possible across the first and the second current path simultaneously in order to charge the electrical energy store when the coupling is connected to the plug.

The charging apparatus has the same advantages as have been described above in conjunction with the system according to the invention for charging an electrical energy store of a vehicle.

The second charge control unit can be designed to switch off the second switching device and/or to switch off the second voltage converter when a fault occurs. The second voltage converter can be designed in such a way that current flow in the direction of the charging apparatus is not possible across the second current path.

The invention further proposes a method for charging an electrical energy store of a the above-described vehicle by means of the above-described charging apparatus. When the common coupling is connected to the plug, the first and the second voltage converter and also the first and the second switching device are driven such that current flows across the first and the second current path simultaneously in order to charge the electrical energy store.

As already described above, this results in more efficient utilization of the charging interface and the systems which are incorporated in the vehicle. This is apparent in the relatively high charging power owing to combining DC charging and AC charging. A consequence of this are the relatively short charging times which can be achieved in order to fully charge the electrical store. Similarly, this results in more efficient utilization of the infrastructure-side supply system connection.

The magnitude of currents in the first and the second current path can be split by driving the first and/or the second voltage converter.

The invention will be explained in greater detail below with reference to an exemplary embodiment in the drawing, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic plan view of a known plug with a number of contacts which, according to the invention, can be used or are used for combined AC and DC charging in accordance with the Combined AC/DC Charging System,

FIG. 2 shows a first possible use of a first group of first contacts of the plug in a first charging mode,

FIG. 3 shows a second possible use of the first group of first contacts of the plug in a second charging mode,

FIG. 4 shows a third possible use of the first group of first contacts of the plug in a third charging mode, and

FIG. 5 is a schematic illustration of a system according to the invention for charging an energy store of a vehicle.

### DETAILED DESCRIPTION OF THE DRAWINGS

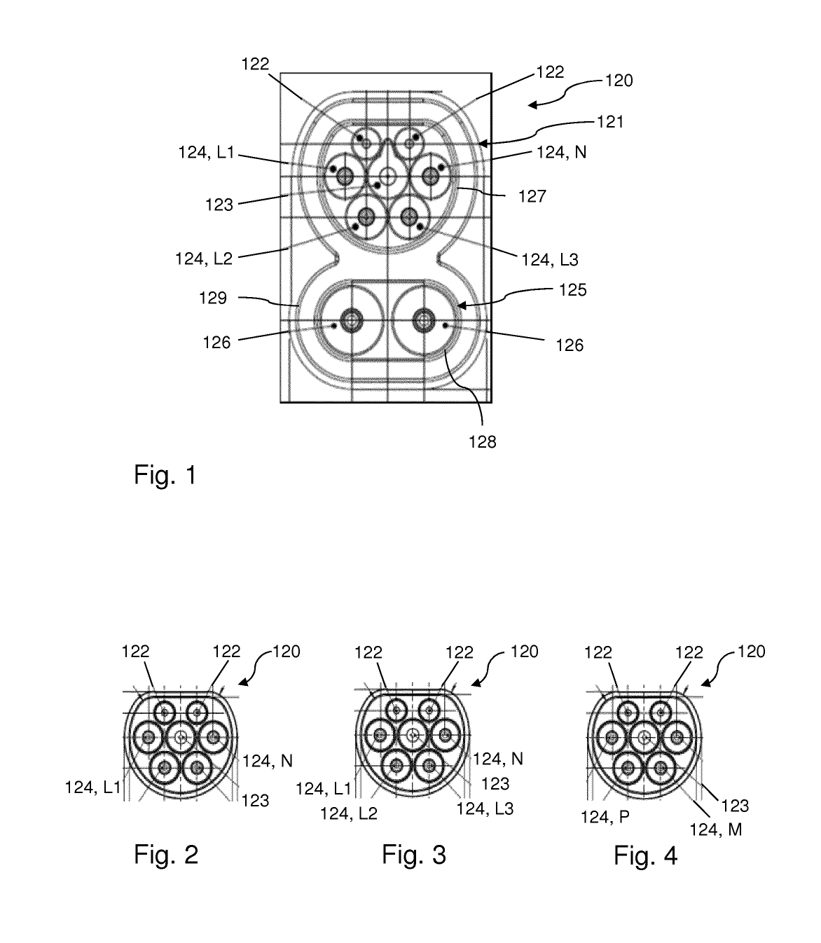

FIG. 1 shows a view of a plug 120, as is used in vehicles which are suitable for the Combined AC/DC Charging System (CCS). The plug 120 which is arranged on the vehicle side comprises a first group 121 of first contacts 122, 123, 124 and also a second group 125 of second contacts 126. The first and second contacts 122, 123, 124, 126 are, for example, in the form of contact pins which extend perpendicularly out of the plane of the drawing toward the viewer. The first contacts 122, 123, 124 are arranged within a housing ring 127 which surrounds said first contacts, that is to say a wall which extends perpendicularly out of the plane of the drawing. A housing ring 128 of this kind likewise surrounds the second contacts 126 of the second group 125 of second contacts. The housing rings 127, 128 are, for their part, in turn surrounded by a housing wall 129 which extends perpendicularly out of the plane of the drawing.

With the design of the first group 121 of first contacts 124 shown in FIG. 1, it is possible to realize one of three charging modes for AC charging (alternating current charging). These different charging modes and the different assignment of the first contacts 124 are illustrated in FIGS. 2 to 4 and will be explained in greater detail below. The charging modes described in IEC 61851-1 “Mode 1” to “Mode 3” can be realized as a result. The first group 121 with the first contacts 124 represents the AC interface. The first contact 123, which is arranged in the middle of the first contacts, represents a connection to the reference potential (PE, ground). The first contacts 124 are connected to the neutral conductor (N) or to one of the three phases L1, L2, L3. The respective drawing of the first contacts 124 in FIG. 1 shows which of the first contacts 124 is connected to which of said phases L1, L2 or L3. The first contacts 124 are connected to the electrical energy store of the vehicle by means of a vehicle-side voltage converter.

The second contacts 126 of the second group 125 serve for DC charging (direct current charging). The second group 125 with the two second contacts 126 therefore represents the DC interface. Rapid charging with direct current at up to 200 A in accordance with IEC 61851-1 “Mode 4” can be performed by means of the second contacts 126. The second contacts 126 are connected to the electrical energy store of the vehicle by means of a switching device. Communication between the vehicle and a charging apparatus which is connected to a power supply system is required for charging the electrical energy store of the vehicle. Communication between a vehicle-side charge control means, not illustrated in FIG. 1, and a corresponding charge control means of a charging apparatus takes place by means of the first contacts of the first group 121 which are identified by reference symbol 122.

It should be noted that, irrespective of whether charging of the electrical energy store of the vehicle is intended to take place using alternating current (AC charging) or using direct current (DC charging), the first contacts 122 for communication and the grounding contact 123 are required in principle and contact has to be made with said contacts in a corresponding manner.

In the case of exclusive DC charging (as is carried out in the prior art), this means that the first contacts 124, given a corresponding cable, or a coupling which corresponds to the plug 120 could be dispensed with.

Contacts which are not required can either be dispensed with or electrically disconnected for the different AC charging modes described below in conjunction with FIGS. 2 to 4.

In FIG. 2, only the first contact 124, L1 for the first phase L1 and the first contact 124, N for the neutral conductor are required for AC charging in accordance with IEC 61851-1 “Mode 1”. Slow charging from domestic Schuko power sockets can be performed in this way. The same configuration is required for an AC charging mode in accordance with IEC 61851-1 “Mode 2” when charging is intended to take place in a single phase for each fixedly coded signal.

According to FIG. 3, all of the first contacts 124 for the phases L1, L2 and L3 and also the neutral conductor N are required. Three-phase AC charging in accordance with IEC 61851-1 “Mode 2” or “Mode 3” is possible as a result.

If, as shown in FIG. 4, the first contacts 124, P and 124, M are assigned direct current, DC charging can take place, wherein the power which can be transmitted is lower than the power when the second contacts 126 are used for DC charging.

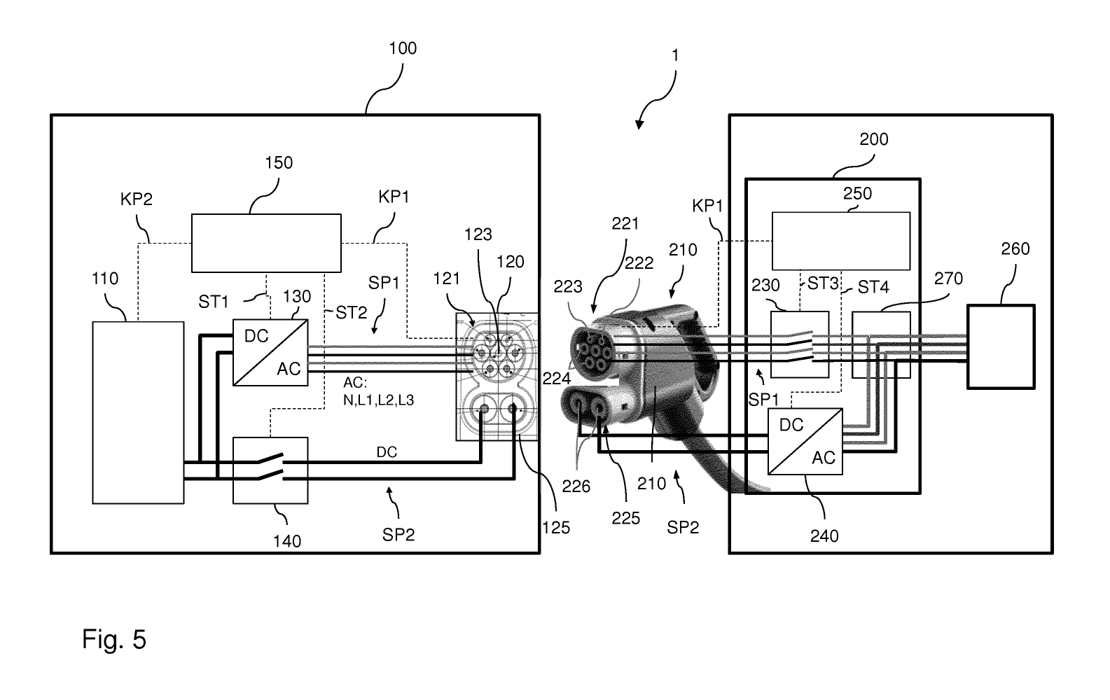

FIG. 5 is a schematic illustration of a system 1 according to the invention for charging an electrical energy store, wherein a plug 120, which is described in FIG. 1, is used on the side of a vehicle 100.

In addition to the plug 120 which has already been described in detail, the vehicle 100 comprises a first voltage converter 130, a first switching device 140, a first charge control unit 150 and also the electrical energy store 110 which has likewise already been mentioned. The electrical energy store 110 is, for example, a high-voltage energy store which serves to supply energy to an electric drive, not illustrated, of the vehicle. The first voltage converter 130 is an AC/DC converter and is connected at the input end to all of the first contacts 124 of the plug 120. At the output end, the first voltage converter 130 is coupled to the electrical energy store 110. The second contacts 126 of the second group 125 of the plug 120 are likewise connected to the electrical energy store 110 by means of the first switching device 140.

The charge control unit 150 serves, amongst other things, to control the switching state of the first voltage converter 130 (on or off) and also of the first switching device 140 (on or off) and also—in the on state—the magnitude of current in each case. Corresponding control signal paths are identified by broken lines and reference symbols ST1, ST2. Furthermore, the first charge control unit 150 is connected to the first contacts 122. A corresponding communication path is identified by KP1.

The current path which is formed between the first contacts 124, the voltage converter 130 and the electrical energy store 110 is called the first current path SP1. The current path which is formed between the second contacts 126, the first switching device 140 and the electrical energy store 110 forms a second current path SP2.

A charging apparatus is identified by reference symbol 200. Said charging apparatus comprises a second switching device 230, a second voltage converter 240 and also a second charge control unit 250. The second charge control unit 250 represents an EV wallbox/charging station control means. The second switching device 230 in the form of an AC/DC converter is connected, at the output end, to third contacts 224 of a first coupling 221. In a corresponding manner, the second voltage converter 240 is connected to a second coupling 225 by means of fourth contacts 226. The first coupling 221 is designed, in respect of the number and arrangement of its contacts, to match the arrangement of the first contacts of the first group of the plug 120. This means that the third contacts comprise contacts 222 for communication, a contact 223 for connection to reference potential, and two or four contacts 224 for connection to the contacts 124 of the vehicle-side plug 120. The second coupling 225 is designed, in respect of the arrangement and number of its fourth contacts 226, in a manner corresponding to the second contacts 126 of the second group 125 of the vehicle-side plug 120. Therefore, two fourth contacts 226 are provided.

The first and the second coupling 221, 225 are designed as a common coupling 210. This means that the first and the second coupling 221, 225 are arranged in a common coupling housing, in particular which cannot be divided or disconnected. As a result, when the coupling 210 is connected to the vehicle-side plug 120, associated first contacts 122, 123, 124 of the first group 121 of the vehicle-side plug 120 are electrically conductively connected to corresponding third contacts 222, 223, 224 of the first coupling 121, and the second contacts 126 of the vehicle-side plug 120 are electrically conductively connected to the fourth contacts 126 of the second coupling 225.

The respective third and fourth contacts 222, 223, 224, 226 are connected to the second switching device 230 and the second voltage converter 240 by means of a cable which is connected to the coupling 210. At the input end, that is to say by way of its AC side, the second voltage converter 240 is connected to a supply system connection 260 to a power supply system by means of a branch 270 (distributor). The second switching device 230 is connected to the supply system connection 260 by means of the branch 270 in a corresponding manner.

The second charge control unit 250 is designed to control the second switching device 230 and also the second voltage converter 240 in respect of their switching states by means of control signal paths ST3, ST4. Furthermore, the second charge control unit 250 is electrically connected to the third contacts 223, which are responsible for communication, of the first coupling 221. If the coupling 210 is connected to the vehicle-side plug 120, the first charge control unit 150 and the second charge control unit 250 exchange data by means of the communication path KP1. Lines by means of which control or communication signals are transmitted are once again identified by broken lines.

By virtue of combining the first and the second coupling 221, 225 in a common coupling 210, it is possible, when the coupling 210 is connected to the vehicle-side plug 120, to simultaneously use the first current path SP1 and the second current path SP2 for charging the electrical energy store 110 of the vehicle 100. In this case, it does not matter which of the above-described AC charging modes is intended to be used.

The invention provides that the electrical energy store 110 is charged by means of the first and the second current path SP1, SP2 with simultaneous AC and DC charging. To this end, the charge control units 150, 250 of the vehicle 100 and the charging apparatus 200 are designed to drive the first and the second voltage converter 130, 240 and the first and the second switching device 140, 230 such that current flow from the charging apparatus 200 in the direction of the electrical energy store 110 is made possible across the first and the second current path SP1, SP2 simultaneously. This means that the first and the second switching device 140, 230 are switched on by the associated charge control unit 150, 250. In a corresponding manner, the first voltage converter and the second voltage converter 240 are driven by the first and, respectively, the second charge control unit 150, 250 in such a way that current flows from the charging apparatus 200 in the direction of the electrical energy store 110 of the vehicle 100.

Driving of the first and the second switching device 140, 230 and also of the first and the second voltage converter 130, 240 is coordinated by suitable communication between the first and the second charge control unit 150, 250 by means of the communication path KP1. In the process, one of the two charge control units 150, 250 can serve as a master and the other can serve as a slave. Expediently, the first charge control unit 150 acts as a master since said first charge control unit also has knowledge of the state (in particular energy content and also other technical parameters) of the electrical energy store 110 by means of the communication path KP2.

In order to suppress current flow from the electrical energy store 110 in the direction of the charging apparatus 200 in the event of a fault occurring, the first and/or the second charge control unit 150, 250, when a fault is detected, firstly have the ability to switch off the first and/or the second switching device 140, 230 and also drive the first and the second DC voltage converter 130, 240 in such a way that the electrical connection between the power supply system and the electrical energy store 110 is broken.

If active driving of this kind by the first and, respectively, the second charge control unit 150, 250 is not intended to be possible, protective arrangements, for example diodes and controlled switches, are preferably additionally provided in the current paths SP1, SP2, said protective arrangements suppressing current flow in the direction of the charging apparatus 200. Protective arrangements of this kind can selectively be provided on the vehicle side and/or in the charging apparatus 200. Furthermore, it is expedient to suppress current flow from the electrical energy store 110 in the direction of the power supply system by suitable design of the first and the second voltage converter 130, 240.

The described procedure allows more efficient utilization of the charging interface and the subsystems which are incorporated in the vehicle. Combining AC charging and DC charging results in a higher charging power. This is associated with shorter charging times for charging the electrical energy store 110. A further advantage is more efficient utilization of the supply system connection of the charging apparatus.

### LIST OF REFERENCE SYMBOLS

1 System for charging an electrical energy store
100 Vehicle
110 Electrical energy store
120 Plug
121 First group of first contacts
122 First contacts (communication)
123 First contact (connection to reference potential)
124 First contacts (connection to alternating-current phases)
125 Second group of second contacts
126 Second contacts (connection to direct current lines)
127 Housing wall (ring)
128 Housing wall (ring)
129 Housing wall
130 First voltage converter
140 First switching device
150 First charge control unit
200 Charging apparatus
210 Common coupling
220 Coupling housing or overall coupling
221 First coupling
222 Third contacts (communication)
223 Third contacts (connection to reference potential)
224 Third contacts (connection to alternating-current phases)
225 Second coupling
226 Fourth contacts (connection to direct current lines)
230 Second switching device
240 Second voltage converter
250 Second charge control unit
260 Supply system connection to power supply system
270 Branch
SP1 First current path
SP2 Second current path
KP1 Communication path between the first and the second charge control unit
KP2 Communication path between the first charge control unit 150 and the electrical energy store 110
ST1 Control signal path for driving the first voltage converter
ST2 Control signal path for driving the first switching device
ST3 Control signal path for driving the second switching device
ST4 Control signal path for driving the second voltage converter

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for charging an electrical energy store of a vehicle, comprising:
a vehicle comprising a plug with a first group of first contacts and a second group of second contacts, wherein, in order to form a first current path, the first contacts of the first group are coupled to the electrical energy store of the vehicle by a first voltage converter which is controllable by a first charge control unit, and wherein, in order to form a second current path, the second contacts of the second group is coupled to the electrical energy store of the vehicle by a first switching device, wherein the switching states of said first switching device are controllable by the first charge control unit; and
a charging apparatus coupled to a power supply system, comprising:
a first coupling with a third number of third contacts, which first coupling can be connected to the first group of first contacts of the plug by the first current path in order to charge the electrical energy store of the vehicle using alternating current, and which first coupling is coupled to the power supply system by a second switching device, wherein the switching states of said second switching device are controllable by a second charge control unit,
a second coupling with a fourth number of fourth contacts, which second coupling can be connected to the second group of second contacts of the plug by the second current path in order to charge the electrical energy store of the vehicle using direct current, and which second coupling is coupled to the power supply system by a second voltage converter which is controllable by the second charge control unit,
wherein the first and the second coupling of the charging apparatus are in the form of a common coupling, so that, when the common coupling is connected to the plug, the first contacts of the plug are electrically conductively connected to one another to the third contacts of the first coupling, and the second contacts of the plug are electrically conductively connected to one another to the fourth contacts of the second coupling;
wherein the first and the second charge control unit are designed to drive the first and the second voltage converter and the first and the second switching device such that current flow is made possible across the first and the second current path simultaneously in order to charge the electrical energy store.

2. The system as claimed in claim 1, wherein the first charge control unit is configured to switch off the first switching device and/or to switch off the first voltage converter when a fault occurs.

3. The system as claimed in claim 1, wherein the second charge control unit is configured to switch off the second switching device and/or to switch off the second voltage converter when a fault occurs.

4. The system as claimed in claim 1, wherein the first voltage converter is configured such current flow in the direction of the charging apparatus is not possible across the first current path.

5. The system as claimed in claim 2, wherein the first voltage converter is configured such current flow in the direction of the charging apparatus is not possible across the first current path.

6. The system as claimed in claim 3, wherein the first voltage converter is configured such current flow in the direction of the charging apparatus is not possible across the first current path.

7. The system as claimed in claim 1, wherein the second voltage converter is configured such that current flow in the direction of the charging apparatus is not possible across the second current path.

8. The system as claimed in claim 2, wherein the second voltage converter is configured such that current flow in the direction of the charging apparatus is not possible across the second current path.

9. The system as claimed in claim 3, wherein the second voltage converter is configured such that current flow in the direction of the charging apparatus is not possible across the second current path.

10. The system as claimed in claim 1, wherein the first switching device comprises a protective arrangement which suppresses current flow in the direction of the charging apparatus.

11. The system as claimed in claim 1, wherein the first charge control unit and the second charge control unit are configured to exchange messages using a communication path in order to simultaneously drive the first and the second voltage converter and also the first and the second switching device, wherein the communication path runs across selected contacts of the first group of first contacts and selected third contacts.

12. A vehicle comprising an electrical energy store which can be charged by a charging apparatus, wherein the vehicle comprises:
a plug with a first group of first contacts and a second group of second contacts;
wherein, in order to form a first current path, the first contacts of the first group are coupled to the electrical energy store of the vehicle by a first voltage converter which is controllable by a first charge control unit,
wherein, in order to form a second current path, the second contacts of the second group are coupled to the electrical energy store of the vehicle by a first switching device, wherein the switching states of said first switching device are controllable by the first charge control unit,
wherein the first charge control unit is configured to drive the first voltage converter and the first switching device such that current flow is made possible across the first and the second current path simultaneously in order to charge the electrical energy store when the first and the second contacts of the plug are electrically conductively connected to a coupling of the charging apparatus, which coupling corresponds to the plug and comprises third and fourth contact pins.

13. The vehicle as claimed in claim 12, wherein the first charge control unit is configured to switch off the first switching device and/or to switch off the first voltage converter when a fault occurs.

14. The vehicle as claimed in claim 12, wherein the first voltage converter is configured such that current flow in the direction of the charging apparatus is not possible across the first current path.

15. The vehicle as claimed in claim 12, wherein the first switching device comprises a protective arrangement which suppresses current flow in the direction of the charging apparatus.

16. A charging apparatus for charging an electrical energy store of a vehicle, which vehicle is configured as claimed in claim 12, comprising:
a first coupling with a third number of third contacts, which first coupling is connected to the first group of first contacts of the plug by the first current path in order to charge the electrical energy store of the vehicle using alternating current, and which first coupling is coupled to the power supply system by a second switching device, wherein the switching states of said second switching device are controllable by a second charge control unit; and
a second coupling with a fourth number of fourth contacts, which second coupling can be connected to the second group of second contacts of the plug by the second current path in order to charge the electrical energy store of the vehicle using direct current, and which second coupling is coupled to the power supply system by a second voltage converter which is controllable by the second charge control unit,
wherein the first and the second coupling of the charging apparatus are in the form of a common coupling, so that, when the common coupling is connected to the plug, the first contacts of the plug are electrically conductively connected to one another to the third contacts of the first coupling, and the second contacts of the plug are electrically conductively connected to one another to the fourth contacts of the second coupling,
wherein the second charge control unit is configured to drive the second voltage converter and the second switching device such that current flow is made possible across the first and the second current path simultaneously in order to charge the electrical energy store when the coupling is connected to the plug.

17. The charging apparatus as claimed in claim 16, wherein the second charge control unit is configured to switch off the second switching device and/or to switch off the second voltage converter when a fault occurs.

18. The charging apparatus as claimed in claim 16, wherein the second voltage converter is configured such that current flow in the direction of the charging apparatus is not possible across the second current path.

19. The charging apparatus as claimed in claim 16, wherein, when the common coupling is connected to the plug, the first and the second voltage converter and also the first and the second switching device are driven such that current flows across the first and the second current path simultaneously in order to charge the electrical energy store.

20. The charging apparatus as claimed in claim 19, wherein the magnitude of currents in the first and the second current path is split by driving the first and/or the second voltage converter.
